(19) United States
(12) Patent Application Publication
(10) Pub. No.: US 2012/0233481 A1
(43) Pub. Date: Sep. 13, 2012

(54) METHOD, APPARATUS AND COMPUTER PROGRAM PRODUCT FOR DECREASING POWER CONSUMPTION OF AN APPARATUS

(75) Inventors: Tero Henttonen, (US); Olli Petteri Alanen, (US)

(73) Assignee: Renesas Mobile Corporation

(21) Appl. No.: 13/041,949

(22) Filed: Mar. 7, 2011

(51) Int. Cl. G06F 1/32

(52) U.S. Cl. 713/323

(57) ABSTRACT

According to an exemplary embodiment of the invention, there is provided a method, comprising: determining that an apparatus has data to be sent to a receiving entity during a sleep period of a power saving cycle, the power saving cycle comprising a wake period during which a receiver is turned on and a sleep period during which the receiver is turned off; and delaying transmission of a data indication to the receiving entity by a delaying amount.

### FIELD OF THE INVENTION

The invention relates to wireless communications. More specifically, the invention relates to a method, apparatus and a computer program product for decreasing power consumption of an apparatus.

### BACKGROUND OF THE INVENTION

Every apparatus having a battery is faced with the question of battery life. Depending on the apparatus and size of the battery, the battery life varies significantly. For example, for laptop computers the battery life question is not so critical because the computer can always be connected to the mains current. For wireless apparatuses, for example, the battery life question is more critical. Usually a wireless apparatus has to be operable longer, in some cases even days, with its own battery without reloading the battery.

In a wireless apparatus, the issue of saving power is taken into account in many ways. When selecting components, their power consumption is considered. In a wireless communication apparatus, a radio part is one of the most power consuming subparts of the apparatus. Power consumption is taken into account in the radio part in many ways. For example, a wireless communication device that uses a time division multiple access (TDMA) technique to access a network, use only some timeslots to receive/transmit data. In other words, during these timeslots the receiver/transmitter is turned on and otherwise (during the remaining timeslots) it is turned off.

Naturally, there are also other network access techniques than the TDMA. A common factor to all these techniques is that there are times when the receiver/transmitter is turned off and times when it is turned on. These times are usually scheduled so that both the wireless apparatus and a base station receiving data from the wireless apparatus know when the receiver/transmitter of the wireless apparatus is turned on and off.

For example, when there are a lot of users connected to a base station, this may cause mobile terminals to buffer a lot of data. A normally bursty traffic may become to a more constant bitrate type of traffic where data buffers in the mobile terminals are never emptied during the connection time. So, for a scheduler in a mobile terminal, it looks like the mobile terminal constantly has data in its buffer. And even in such situations the mobile terminals are typically not scheduled over the whole bandwidth they might still have to keep the receiver active all the time. In such cases, the power consumption of the mobile terminal might be as bad as having the receiver being turned on all the time.

Based on the above, there is a need for an improved solution which takes into account power saving characteristics of an apparatus in data transmissions.

### SUMMARY

According to a first aspect of the invention, there is provided a method comprising: determining that an apparatus has data to be sent to a receiving entity during a sleep period of a power saving cycle, the power saving cycle comprising a wake period during which a receiver is turned on and a sleep period during which the receiver is turned off; and delaying transmission of a data indication to the receiving entity by a delaying amount.

In one embodiment, the delaying comprises delaying the transmission until the beginning of the next wake period.

In one embodiment, the method further comprises receiving delaying information comprising the delaying amount from the receiving entity.

In one embodiment, the delaying amount is dependent on at least one of a traffic type of the data to be sent and at least one quality of service parameter.

In one embodiment, the method further comprises receiving delaying information comprising the delaying amount from the receiving entity as part of signaling relating to configuring the power saving cycle.

In one embodiment, the method further comprises determining the delaying amount based on at least one of the length of the power saving cycle, data traffic type, the amount of data to be sent and at least one quality of service parameter.

In one embodiment, the power saving cycle comprises a discontinuous reception and/or discontinuous transmission cycle.

In one embodiment, the data indication comprises a scheduling request message or a buffer status report message.

According to a second aspect of the invention, there is provided an apparatus comprising at least one processor and at least one memory including computer program code. The at least one memory and the computer program code configured to, with the at least one processor, cause the apparatus to perform at least the following: determining that an apparatus has data to be sent to a receiving entity during a sleep period of a power saving cycle, the power saving cycle comprising a wake period during which a receiver is turned on and a sleep period during which the receiver is turned off; and delaying transmission of a data indication to the receiving entity by a delaying amount.

In one embodiment, the delaying comprises delaying the transmission until the beginning of the next wake period.

In one embodiment, the at least one memory and the computer program code configured to, with the at least one processor, cause the apparatus to perform: receiving delaying information comprising the delaying amount from the receiving entity.

In one embodiment, the delaying amount is dependent on at least one of the length of the power saving cycle, data traffic type, the amount of data to be sent and at least one quality of service parameter.

In one embodiment, the at least one memory and the computer program code configured to, with the at least one processor, cause the apparatus to perform: receiving delaying information comprising the delaying amount from the receiving entity as part of signaling relating to configuring the power saving cycle.

In one embodiment, the at least one memory and the computer program code configured to, with the at least one processor, cause the apparatus to perform: determining the delaying amount based on at least one of the length of the power saving cycle, data traffic type and at least one quality of service parameter.

In one embodiment, the power saving cycle comprises a discontinuous reception and/or discontinuous transmission cycle.

In one embodiment, the data indication comprises a scheduling request message or a buffer status report message.

According to a second aspect of the invention, there is provided a computer program product comprising a computer-readable medium bearing computer program code embodied therein for use with a computer, the computer program code comprising: code for determining that an apparatus has data to be sent to a receiving entity during a sleep period of a power saving cycle, the power saving cycle comprising a wake period during which a receiver is turned on and a sleep period during which the receiver is turned off; and code for delaying transmission of a data indication to the receiving entity by a delaying amount.

In another embodiment of the invention, it is possible to combine one or more of the above embodiments to form a further embodiment of the invention.

In one embodiment of the invention, the apparatus is user equipment of the Long Term Evolution (LTE) and the receiving entity is an evolved NodeB of the LTE.

Advantages relating to at least some embodiments of the invention include improved power savings since the apparatus is able to spend more time in a sleep mode.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 discloses a block diagram of a method according to one embodiment of the present invention;

FIG. 2 discloses a solution for delaying sending data according to one embodiment of the present invention,

FIG. 3 discloses an example of shaping traffic according to one embodiment of the present invention; and

FIG. 4 discloses a simplified block diagram of an exemplary wireless device according to one embodiment of the present invention.

### DETAILED DESCRIPTION OF THE INVENTION

Reference will now be made in detail to the embodiments of the present invention, examples of which are illustrated in the accompanying drawings.

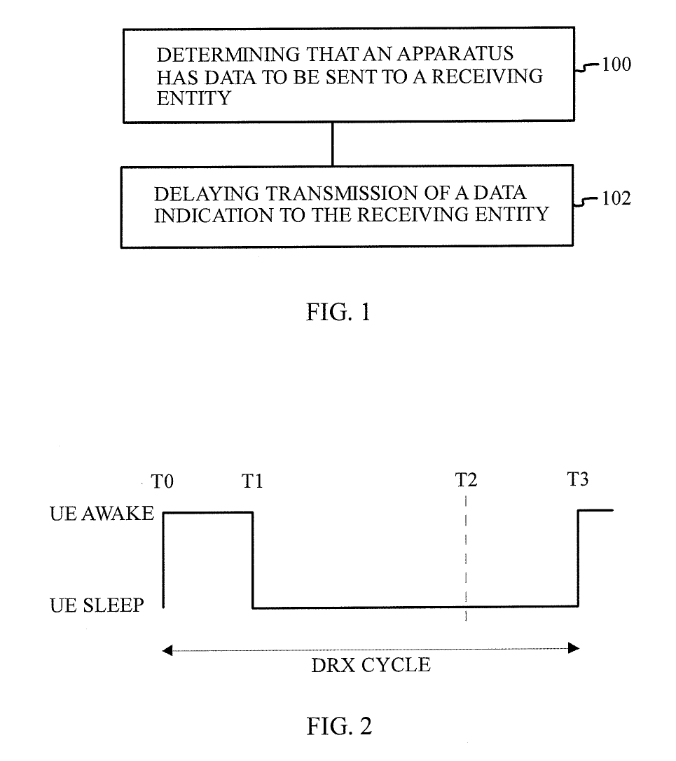

FIG. 1 is a block diagram of a method according to one embodiment of the invention. In step 100, an apparatus determines that the apparatus has data to be sent to a receiving entity during a sleep period of a power saving cycle. The data may be user data or control data. The power saving cycle comprises a wake period during which a receiver is turned on and a sleep period during which the receiver is turned off. In step 102, the apparatus is configured to delay transmission of a data indication to the receiving entity by a delaying amount. In one embodiment, the data indication only indicates that the apparatus has data to be sent. In another embodiment, the data indication also includes the actual data to be sent.

In one embodiment of FIG. 1, the apparatus is user equipment of the Long Term Evolution (LTE) and the receiving entity is an evolved NodeB of the LTE.

FIG. 2 discloses a solution for delaying sending data according to one embodiment of the invention. The embodiment disclosed in FIG. 2 uses discontinuous reception (DRX) as an example to save power in user equipment. Discontinuous reception is a method that aims to conserve battery power of the user equipment, e.g. a mobile phone. Each user equipment is assigned a periodic wake on period. During the wake period, the user equipment listens to the network and during other times it turns its receiver off and goes into a power saving mode. The length of the wake period and other parameters are determined e.g. by the network and can be assigned to the user equipment when it first registers with the network. Furthermore, during periods when the receiver of the user equipment is turned off, an evolved NodeB of a Long Term Evolution (LTE) evolved UMTS Terrestrial Radio Access Network (UTRAN) does not schedule any traffic for the user equipment.

The DRX cycle is a periodic cycle. The DRX cycle starts at moment TO and the user equipment is ready to transmit data to the network and to receive data from the network during T0-T1. At T1 the user equipment turns its receiver off. The wake on period (T0-T1) is typically shorter than the sleep period (T1-T3). At T2 data arrives at a data buffer of the user equipment and is to be sent to the network. In a normal situation the user equipment would send a data indication to the network. The data indication indicates that the user equipment has data to be sent to the network. The data indication refers e.g. to a scheduling request (SR) and/or to a buffer status report (BSR). In accordance with the invention, the user equipment is however configured to delay transmission of the data indication to the network. Thus the user equipment stays longer in the power saving mode (sleep mode where the receiver is turned off). When the user equipment is allowed to delay sending a scheduling request and/or a buffer status report, this allows the user equipment to shape the uplink traffic to the network in media access control (MAC) layer (where the SR/BSR is sent from). Thus DRX opportunities are maximized.

In one embodiment of FIG. 2, the user equipment is by default allowed to delay sending a SR/BSR until the beginning of the next wake on period. In another embodiment, a maximum delaying period for sending a SR/BSR is used by the user equipment. If the user equipment is in the sleep period and data arrives at its buffer and the time period to the beginning of the next wake on period is longer than the maximum delaying period for sending a SR/BSR, the user equipment would be allowed to send the SR/BSR. The sending can be at some point during the maximum delaying period or when the maximum delaying period ends.

In one embodiment of FIG. 2, an evolved NodeB makes the determination of an appropriate delay amount and signals it to user equipment, i.e. how much the user equipment is allowed to delay sending the data indication. In one embodiment, the signaling is made with a separate signaling message from the evolved NodeB to the user equipment. In another embodiment, the necessary signaling is performed when DRX parameters are received with the user equipment from the evolved NodeB. In another embodiment, the user equipment is able to determine how long it is allowed to delay sending the data indication to the evolved NodeB. Regardless of which of the user equipment or the evolved NodeB is making the determination, the determination may be made based on various parameters, e.g. based on at least one of the length of the DRX cycle, data traffic type, the amount of data to be sent and at least one quality of service parameter. In other words, the amount of allowed delay may vary between different services. In one embodiment, the at least one quality of service parameter refers to at least on of resource type, priority, packet delay budget and packet error loss rate.

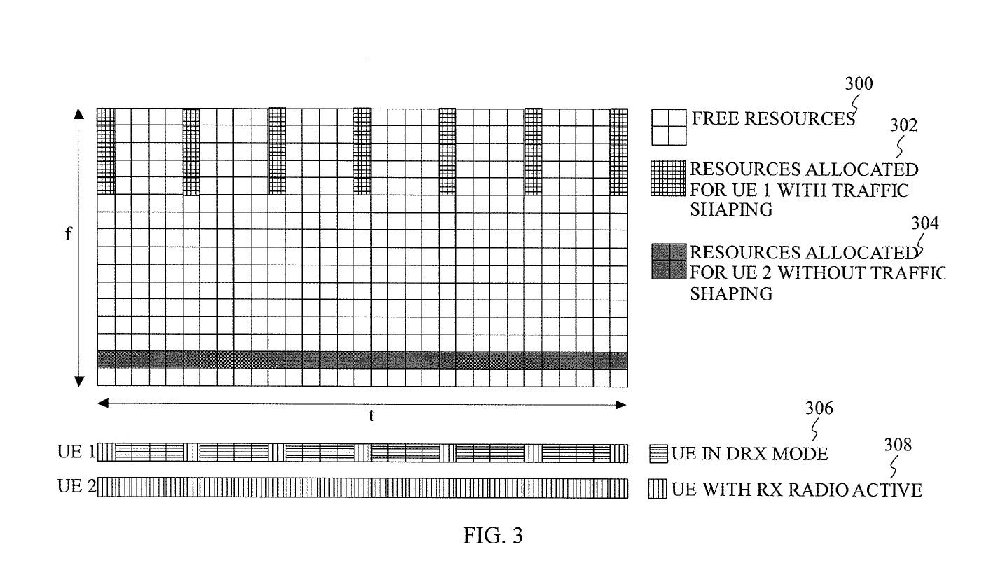

FIG. 3 discloses an example of shaping traffic according to one embodiment of the present invention. In FIG. 3 blocks 304 present transmitted data when no traffic shaping is utilized. Furthermore, in this example the traffic is constant bit rate (CBR) kind of traffic with quite short inter-packet interval. Such a small inter-packet interval effectively disables the possibility for any power savings with the DRX. However, when some traffic shaping is utilized (blocks 302) and more bursty traffic is considered, the user equipment 1 is able to keep the RX radio in power saving mode for most of the time (as represented by blocks 300 and 306). With respect to user equipment 2, it has RX radio active all the time (as represented by blocks 308).

The performance degradation in the embodiment of FIG. 3 may be that the delays of some of the packets will increase. For some traffic models, like video streaming with buffering, this might not be such a big issue, however, as long as the overall throughput remains good enough. By an appropriate delaying procedure traffic is shaped to be more bursty and better fit for the currently used DRX pattern in the user equipment. Thus, time is spent more in DRX thus saving power while still providing almost as good quality of service than without DRX.

In one embodiment of the invention, when considering downlink traffic towards user equipment, an evolved NodeB may shape traffic towards the user equipment by scheduling the user equipment in a more bursty manner. In another embodiment, the evolved eNB may use the at least one of a traffic type of the data to be sent and at least one quality of service parameter to determine how much to delay sending data towards the user. In another embodiment, the evolved NodeB may control downlink scheduling assignments to best enable the user equipment to use DRX opportunities.

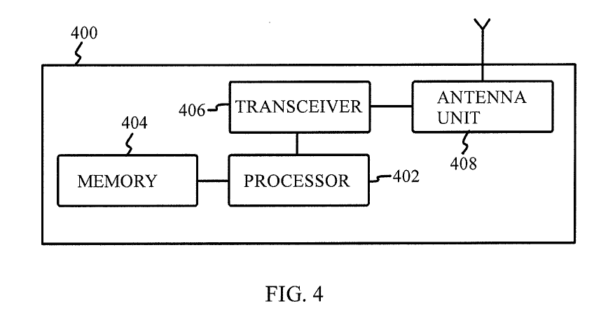

FIG. 4 discloses a simplified block diagram of an exemplary apparatus that is suitable for use in practicing the exemplary embodiments of at least part of this invention. In FIG. 4, the apparatus 400 may include a processor 402, a memory 404 coupled to the processor 402, and a suitable transceiver 406 (having a transmitter (TX) and a receiver (RX)) coupled to the processor 402, coupled to an antenna unit 408.

The processor 402 or some other form of generic central processing unit (CPU) or special-purpose processor such as digital signal processor (DSP), may operate to control the various components of the apparatus 400 in accordance with embedded software or firmware stored in memory 404 or stored in memory contained within the processor 402 itself. In addition to the embedded software or firmware, the processor 402 may execute other applications or application modules stored in the memory 404 or made available via wireless network communications. The application software may comprise a compiled set of machine-readable instructions that configures the processor 402 to provide the desired functionality, or the application software may be high-level software instructions to be processed by an interpreter or compiler to indirectly configure the processor 402.

The transceiver 406 is for bidirectional wireless communications with another wireless device, e.g. an evolved NodeB. The transceiver 406 may provide frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. For the purposes of clarity, the description here separates the description of this signal processing from the RF and/or radio stage and conceptually allocates that signal processing to some analog baseband processing unit and/or the processor 402 or other central processing unit. In some embodiments, the transceiver 406, portions of the antenna unit 408, and an analog baseband processing unit may be combined in one or more processing units and/or application specific integrated circuits (ASICs).

The antenna unit 408 may be provided to convert between wireless signals and electrical signals, enabling the apparatus 400 to send and receive information from a cellular network or some other available wireless communications network or from a peer wireless device. The antenna unit 408 may include antenna tuning and/or impedance matching components, RF power amplifiers, and/or low noise amplifiers.

The apparatus 400 is e.g. a wireless communication apparatus and in one embodiment user equipment of a Long Term Evolution (LTE) network. The basic structure of a receiving entity (e.g. an evolved NodeB) is similar to the structure of the apparatus 400.

In the above, the invention has been described using Long Term Evolution (LTE) evolved UMTS Terrestrial Radio Access Network (UTRAN) including user equipment and eNodeB. However, any other technology which includes a wireless interface between an apparatus and a receiving entity (e.g. a base station or another entity of a network) can be used as long as the apparatus employs a power saving cycle where at least the receiver of the apparatus is periodically turned on and off to save power. In another embodiment, also the transmitter of the apparatus may be turned of either simultaneously with the receiver or at different times.

Furthermore, in the above description, where the invention has been described using the LTE as an example, discontinuous reception (DRX) in practice equates to discontinues transmission (DTX). In another embodiment of the invention, DRX and DTX may be separately in use.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
determining that an apparatus has data to be sent to a receiving entity during a sleep period of a power saving cycle, the power saving cycle comprising a wake period during which a receiver is turned on and a sleep period during which the receiver is turned off; and
delaying transmission of a data indication to the receiving entity by a delaying amount.

2. The method according to claim 1, wherein the delaying comprises delaying the transmission until the beginning of the next wake period.

3. The method according to claim 1, further comprising receiving delaying information comprising the delaying amount from the receiving entity.

4. The method according to claim 1, wherein the delaying amount is dependent on at least one of the length of the power saving cycle, data traffic type, the amount of data to be sent and at least one quality of service parameter.

5. The method according to claim 1, further comprising:
receiving delaying information comprising the delaying amount from the receiving entity as part of signaling relating to configuring the power saving cycle.

6. The method according to claim 1, further comprising:
determining the delaying amount based on at least one of the length of the power saving cycle, data traffic type, the amount of data to be sent and at least one quality of service parameter.

7. The method according to claim 1, wherein the power saving cycle comprises a discontinuous reception and/or discontinuous transmission cycle.

8. The method according to claim 1, wherein the data indication comprises a scheduling request message or a buffer status report message.

9. An apparatus, comprising:
at least one processor; and
at least one memory including computer program code;
the at least one memory and the computer program code configured to, with the at least one processor, cause the apparatus to perform at least the following:
determining that apparatus has data to be sent to a receiving entity during a sleep period of a power saving cycle, the power saving cycle comprising a wake period during which a receiver is turned on and a sleep period during which the receiver is turned off; and
delaying transmission of a data indication to the receiving entity by a delaying amount.

10. The apparatus according to claim 9, wherein the delaying comprises delaying the transmission until the beginning of the next wake period.

11. The apparatus according to claim 9, wherein the at least one memory and the computer program code configured to, with the at least one processor, cause the apparatus to perform:
receiving delaying information comprising the delaying amount from the receiving entity.

12. The apparatus according to claim 9, wherein the delaying amount is dependent on at least one of the length of the power saving cycle, data traffic type, the amount of data to be sent and at least one quality of service parameter.

13. The apparatus according to claim 9, wherein the at least one memory and the computer program code configured to, with the at least one processor, cause the apparatus to perform:
receiving delaying information comprising the delaying amount from the receiving entity as part of signaling relating to configuring the power saving cycle.

14. The apparatus according to claim 9, wherein the at least one memory and the computer program code configured to, with the at least one processor, cause the apparatus to perform:
determining the delaying amount based on at least one of the length of the power saving cycle, data traffic type and at least one quality of service parameter.

15. The apparatus according to claim 9, wherein the power saving cycle comprises a discontinuous reception and/or discontinuous transmission cycle.

16. The apparatus according to claim 9, wherein the data indication comprises a scheduling request message or a buffer status report message.

17. A computer program product comprising a computer-readable medium bearing computer program code embodied therein for use with a computer, the computer program code comprising:
code for determining that an apparatus has data to be sent to a receiving entity during a sleep period of a power saving cycle, the power saving cycle comprising a wake period during which a receiver is turned on and a sleep period during which the receiver is turned off; and
code for delaying transmission of a data indication to the receiving entity by a delaying amount.
